(19) United States
(12) Patent Application Publication
(10) Pub. No.: US 2026/0279109 A1
(43) Pub. Date: Sep. 17, 2026

(54) RELAY DEVICE, CONTROL METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takuya KOBAYASHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/166,939

(22) PCT Filed: Mar. 14, 2024
(86) PCT No.: PCT/JP2024/010104

§ 371 Date: Sep. 19, 2025

(30) Foreign Application Priority Data
Mar. 20, 2023 (JP) 2023-044468

(51) Int. Cl. G07C 5/08; B60R 16/023; G05B 15/02

(52) U.S. Cl. CPC G07C 5/0808; B60R 16/023; G05B 15/02; G07C 5/0816

(57) ABSTRACT

A relay device includes: a reception unit configured to receive a first cluster frame transmitted by a first in-vehicle control device, a second in-vehicle control device; a monitoring unit configured to monitor a frame reception status of the reception unit and acquire a generation state of the first cluster frame; a determination unit configured to determine whether the first cluster is normal or abnormal based on the generation state of the first cluster frame acquired by the monitoring unit and a determination reference regarding a frame generation state; and a start-up control unit configured to, in a case where the determination unit determines that the first cluster is normal, transmit the first cluster frame received from the first in-vehicle control device to the second in-vehicle control device, and in a case where the first cluster is abnormal, not transmit the first cluster frame to the second in-vehicle control device.

### CROSS-REFERENCE TO RELATED APPLICATIONS

This application is the U.S. national stage of PCT/JP2024/010104 filed on Mar. 14, 2024, which claims priority of Japanese Patent Application No. JP 2023-044468 filed on Mar. 20, 2023, the contents of which are incorporated herein.

### TECHNICAL FIELD

The present disclosure relates to a relay device, a control method, and a computer program.

### BACKGROUND

Vehicle are equipped with various types of in-vehicle devices, such as the following: control ECUs (Electronic Control Units) that control the engine, transmission, and the like; vehicle body ECUs that control the headlights, power windows, and the like; and information ECUs for navigation devices, multimedia devices, and the like. In recent years, in an in-vehicle system in which various in-vehicle devices are connected to each other via a bus network, a partial network function has been developed, and according to this partial network function, the in-vehicle devices are divided into clusters called Partial Network Clusters (PNCs) for each function (service), and when a certain service is to be executed, the in-vehicle devices in the PNC used to execute that service are woken up and the in-vehicle devices in the other PNCs are set to the sleep state. The partial network function is standardized in ISO (International Organization for Standardization) 11898-6.

AUTOSAR Layered Software Architecture, pp. 182-186 discloses a technique for the exchange of PNC requests and release information between ECUs with use of network management messages (NM messages).

JP 2019-146462A discloses a monitoring system that includes a control device for controlling the supply of power from a main battery to a sub battery, and a comparator for comparing the battery voltage of the sub battery with a reference voltage and starting up the control device if the battery voltage falls to the reference voltage or below, and in this monitoring system, power supply control is started when the control device is started up. With this monitoring system, it is possible to avoid excessive discharging of the battery, such as the case where the terminal voltage of the battery drops to such an extent that an electronic device connected to the battery cannot operate (hereinafter referred to as “excessive discharge”).

There is a demand for further suppression of power consumption in an in-vehicle system.

### SUMMARY

A relay device according to an aspect of the present disclosure is a relay device for relaying communication between in-vehicle control devices that communicate with each other via a communication bus, the relay device including: a reception unit configured to receive a first cluster frame transmitted by a first in-vehicle control device, which belongs to a first cluster that executes a first function, with a second in-vehicle control device belonging to the first cluster as a destination; a monitoring unit configured to monitor a frame reception status of the reception unit and acquire a generation state of the first cluster frame transmitted by the first in-vehicle control device with the second in-vehicle control device as a destination; a determination unit configured to determine whether the first cluster is normal or abnormal based on the generation state of the first cluster frame acquired by the monitoring unit and a determination reference regarding a frame generation state; and a start-up control unit configured to, in a case where the determination unit determines that the first cluster is normal, transmit the first cluster frame received from the first in-vehicle control device to the second in-vehicle control device, and in a case where the determination unit determines that the first cluster is abnormal, not transmit the first cluster frame received from the first in-vehicle control device to the second in-vehicle control device.

The present disclosure not only can be realized as a relay device having the above-described characteristic configuration, a control method in which characteristic processing in the relay device is performed as steps, and a control program for causing the relay device to execute the characteristic processing, but also can be realized in an aspect in which part or all of the relay device is realized as a semiconductor integrated circuit.

### Advantageous Effects

According to the present disclosure, it is possible to suppress power consumption in an in-vehicle system by stopping operation of a second in-vehicle control device that belongs to a cluster determined to be abnormal.

### BRIEF DESCRIPTION OF DRAWINGS

FIG. 1 is a block diagram illustrating an example of the configuration of an in-vehicle system including a relay device according to a first embodiment.

FIG. 2 is a block diagram illustrating an example of the configuration of the relay device according to the first embodiment.

FIG. 3 is a block diagram illustrating an example of the configuration of the in-vehicle control device according to the first embodiment.

FIG. 4 illustrates an example of a cluster table showing the in-vehicle control devices that belong to each cluster.

FIG. 5 is a functional block diagram illustrating an example of functions of the relay device according to the first embodiment.

FIG. 6 is a diagram illustrating an example of determination references for determining whether a cluster is normal or abnormal.

FIG. 7 is a schematic diagram illustrating a flow of data when a cluster frame generation state is normal.

FIG. 8 is a schematic diagram illustrating a flow of data when the cluster frame generation state is abnormal.

FIG. 9 is a schematic diagram illustrating a flow of data when the cluster frame generation state is abnormal.

FIG. 10 is a flowchart illustrating an example of operation of the relay device according to the first embodiment.

FIG. 11 is a functional block diagram illustrating an example of functions of a relay device according to a second embodiment.

FIG. 12 is a flowchart illustrating an example of operation of the relay device according to the second embodiment.

FIG. 13 is a diagram illustrating an example of determination references in a modified example of the relay device.

### DETAILED DESCRIPTION OF PREFERRED EMBODIMENTS

The following is an overview of embodiments of the present disclosure.

In a first aspect, a relay device according to an embodiment is a relay device for relaying communication between in-vehicle control devices that communicate with each other via a communication bus, the relay device including: a reception unit configured to receive a first cluster frame transmitted by a first in-vehicle control device, which belongs to a first cluster that executes a first function, with a second in-vehicle control device belonging to the first cluster as a destination; a monitoring unit configured to monitor a frame reception status of the reception unit and acquire a generation state of the first cluster frame transmitted by the first in-vehicle control device with the second in-vehicle control device as a destination; a determination unit configured to determine whether the first cluster is normal or abnormal based on the generation state of the first cluster frame acquired by the monitoring unit and a determination reference regarding a frame generation state; and a start-up control unit configured to, in a case where the determination unit determines that the first cluster is normal, transmit the first cluster frame received from the first in-vehicle control device to the second in-vehicle control device, and in a case where the determination unit determines that the first cluster is abnormal, not transmit the first cluster frame received from the first in-vehicle control device to the second in-vehicle control device. According to this configuration, it is possible to stop operation of the second in-vehicle control device that belongs to the cluster determined to be abnormal, thereby suppressing the power consumption of the in-vehicle system.

In a second aspect according to the first aspect, a configuration is possible in which in a case where the determination unit determines that the first cluster is abnormal, the start-up control unit transmits, to the second in-vehicle control device, a stop frame for stopping operation of the second in-vehicle control device. According to this configuration, the relay device can actively stop the second in-vehicle control device.

In a third aspect according to the first or the second aspect, a configuration is possible in which the generation state of the first cluster frame includes at least one of a generation duration indicating a duration for which the first cluster frame has been transmitted periodically, and a generation count of the first cluster frame. According to this configuration, whether the first cluster that executes the first function is normal or abnormal can be determined based on an abnormal frame generation duration or generation count.

In a fourth aspect according to any one of the first to the third aspects, a configuration is possible in which in a case where a power storage device for supplying power to the in-vehicle control devices is not being charged, the determination unit determines whether the first cluster is normal or abnormal based on a first determination reference, and in a case where the power storage device is being charged, the determination unit determines whether the first cluster is normal or abnormal based on a second determination reference more relaxed than the first determination reference. According to this configuration, there may be a cluster that would be determined to be abnormal if the power storage device were not being charged, but would not necessarily be said to be abnormal if the power storage device were being charged, and it is possible to appropriately determine whether or not such a cluster is normal or abnormal.

In a fifth aspect according to any one of the first to the fourth aspects, a configuration is possible in which the reception unit receives a second cluster frame transmitted by a third in-vehicle control device, which belongs to a second cluster that executes a second function, with a fourth in-vehicle control device belonging to the second cluster as a destination, the monitoring unit acquires a generation state of the second cluster frame transmitted by the third in-vehicle control device with the fourth in-vehicle control device as a destination, the determination unit determines whether the second cluster is normal or abnormal based on the generation state of the second cluster frame acquired by the monitoring unit and the determination reference, and in both a case where the determination unit determines that the second cluster is normal and a case where the determination unit determines that the second cluster is abnormal, the start-up control unit transmits the second cluster frame received from the third in-vehicle control device to the fourth in-vehicle control device. According to this configuration, even if the determination unit determines that a cluster is abnormal, if the function of that cluster needs to be executed, it is possible to cause that function to be executed.

In a sixth aspect according to the fifth aspect, a configuration is possible in which the first function is a function executed in a case where a remaining capacity of a power storage device for supplying power to the in-vehicle control devices is a specified value or higher, and the second function is a function executed even in a case where the remaining capacity is below the specified value. According to this configuration, in the case where the determination unit determines that a cluster is abnormal, if it is necessary to execute the function of that cluster even when the remaining capacity of the power storage device is less than the specified value, it is possible to cause that function to be executed.

In a seventh aspect according to any one of the first to the sixth aspects, a configuration is possible in which the relay device further includes a notification unit configured to, in a case where the determination unit determines that the first cluster is abnormal, notify a user that the first cluster is abnormal. According to this configuration, the user can find out that a cluster is abnormal. Upon receiving the notification, the user can respond to the abnormality.

In an eighth aspect according to the seventh aspect, a configuration is possible in which in a case where the notification unit notified the user that the first cluster is abnormal, if the relay device receives a command to continue execution of the first function from the user, the start-up control unit transmits the first cluster frame received from the first in-vehicle control device to the second in-vehicle control device. According to this configuration, even if a cluster is determined to be abnormal, the cluster can execute the corresponding function based on a user instruction if the user intends for the function to be executed.

In a ninth aspect according to any one of the first to the eighth aspects, a configuration is possible in which the first in-vehicle control device further belongs to a second cluster that executes a second function different from the first function, and in a case where the first function is being executed alone, the determination unit determines whether the first cluster is normal or abnormal based on a first determination reference, and in a case where the first function and the second function are being executed concurrently, the determination unit determines whether the first cluster is normal or abnormal based on a second determination reference more relaxed than the first determination reference. According to this configuration, in the case where the first function and the second function are being executed concurrently, a load is placed on the first in-vehicle control device that belongs to both clusters, and it is possible to avoid the case where a cluster that is not actually abnormal is erroneously determined to be abnormal due to the determination being made based on the determination reference of the first cluster or the determination reference of the second cluster.

In a tenth aspsect according to any one of the first to the ninth aspects, a configuration is possible in which the determination reference is determined based on a power storage capacity of a power storage device for supplying power to the in-vehicle control devices and an amount of power consumed by the first cluster. According to this configuration, the determination reference is determined such that a cluster does not use all of the power in the power storage device, thereby making it possible to avoid excessive discharge of the power storage device.

In an eleventh aspect, a control method according to an embodiment is a control method for controlling a relay device for relaying communication between in-vehicle control devices that communicate with each other via a communication bus, the control method including the steps of: receiving a first cluster frame transmitted by a first in-vehicle control device, which belongs to a first cluster that executes a first function, with a second in-vehicle control device belonging to the first cluster as a destination; monitoring a frame reception status of received frames and acquiring a generation state of the first cluster frame transmitted by the first in-vehicle control device with the second in-vehicle control device as a destination; determining whether the first cluster is normal or abnormal based on the acquired generation state of the first cluster frame and a determination reference regarding a frame generation state; and in a case where the first cluster is determined to be normal, transmitting the first cluster frame received from the first in-vehicle control device to the second in-vehicle control device, and in a case where the first cluster is determined to be abnormal, not transmitting the first cluster frame received from the first in-vehicle control device to the second in-vehicle control device. According to this configuration, it is possible to stop operation of the second in-vehicle control device that belongs to the cluster determined to be abnormal, thereby suppressing the power consumption of the in-vehicle system.

A computer program according to an embodiment is a computer program for use in a relay device for relaying communication between in-vehicle control devices that communicate with each other via a communication bus, the computer program causing execution of the steps of: receiving a first cluster frame transmitted by a first in-vehicle control device, which belongs to a first cluster that executes a first function, with a second in-vehicle control device belonging to the first cluster as a destination; monitoring a frame reception status of received frames and acquiring a generation state of the first cluster frame transmitted by the first in-vehicle control device with the second in-vehicle control device as a destination; determining whether the first cluster is normal or abnormal based on the acquired generation state of the first cluster frame and a determination reference regarding a frame generation state; and in a case where the first cluster is determined to be normal, transmitting the first cluster frame received from the first in-vehicle control device to the second in-vehicle control device, and in a case where the first cluster is determined to be abnormal, not transmitting the first cluster frame received from the first in-vehicle control device to the second in-vehicle control device. According to this configuration, it is possible to stop operation of the second in-vehicle control device that belongs to the cluster determined to be abnormal, thereby suppressing the power consumption of the in-vehicle system.

### First Embodiment

### Details of First Embodiment of Present Disclosure

Hereinafter, details of embodiments of the present disclosure will be described with reference to the drawings. Note that at least portions of the embodiments described below may be combined in any manner.

### In-Vehicle System

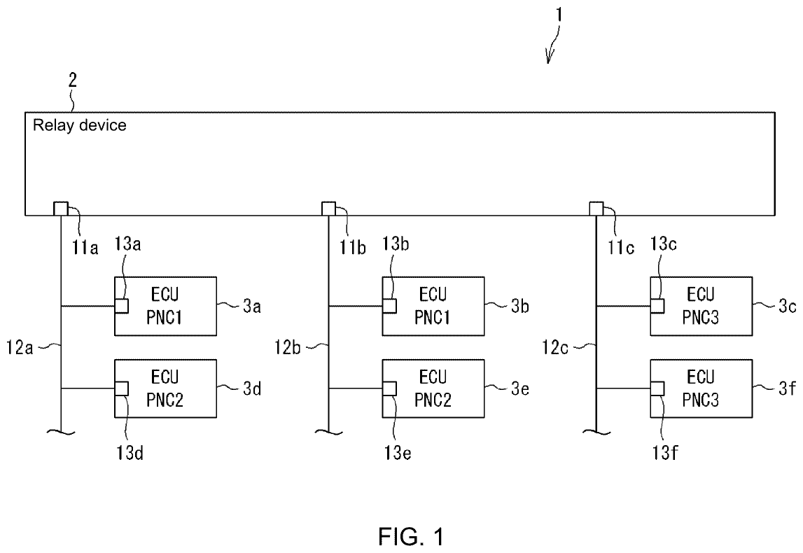

FIG. 1 is a block diagram illustrating an example of the configuration of an in-vehicle system including a relay device according to a first embodiment. An in-vehicle system 1 is for installation in a vehicle. The relay device is sometimes called an integrated ECU or a gateway.

The in-vehicle system 1 according to the first embodiment includes a relay device 2 as well as an in-vehicle control device 3a, an in-vehicle control device 3b, an in-vehicle control device 3c, an in-vehicle control device 3d, an in-vehicle control device 3e, and an in-vehicle control device 3f. The in-vehicle control devices may be called ECUs, and hereinafter the in-vehicle control devices are sometimes referred to as ECUs. The in-vehicle system 1 is an in-vehicle network configured by the relay device 2, the ECU 3a, the ECU 3b, the ECU 3c, the ECU 3d, the ECU 3e, the ECU 3f, and communication cables (communication buses) that connect them to each other. Note that the ECU 3a, the ECU 3b, the ECU 3c, the ECU 3d, the ECU 3e, and the ECU 3f are sometimes collectively referred to as the “ECUs 3” below.

The ECUs 3 are disposed in various portions of the vehicle. The ECUs 3 individually control the hardware of the corresponding portions of the vehicle and monitor the status of the hardware of the corresponding portions of the vehicle. For example, the ECUs 3 include a control ECU, a vehicle body ECU, and an information ECU.

The relay device 2 is connected to the ECUs 3 via communication buses 12a, 12b, and 12c, which are CAN (Controller Area Network) buses, for example. Specifically, the relay device 2 includes communication interfaces (communication I/Fs) 11a, 11b, and 11c. The communication I/F 11a is connected to the communication bus 12a. The ECU 3a and the ECU 3d are connected to the communication bus 12a. The communication I/F 11b is connected to the communication bus 12b. The ECUs 3b and 3e are connected to the communication bus 12b. The ECUs 3c and 3f are connected to the communication bus 12c. The relay device 2 can communicate with each of the ECUs 3.

The ECUs 3 respectively include communication I/Fs 13a, 13d, 13b, 13e, 13c, and 13f that are connected to the communication buses. The communication I/Fs 13a, 13d, 13b, 13e, 13c, and 13f are compatible I/Fs that are compatible with the partial network function. The ECUs 3 each use a communication protocol that supports the partial network function. Examples of the communication protocol include CAN, CAN FD (CAN with Flexible Data Rate) and CAN PN (CAN with Partial Networking).

The relay device 2 functions as a gateway that relays communication between the ECUs 3. The ECUs 3 can transmit frames. The relay device 2 relays frames between ECUs that are connected to different buses. For example, the relay device 2 can relay frames between the ECU 3a connected to the communication bus 12a, the ECU 3b connected to the communication bus 12b, and the ECU 3f connected to the communication bus 12c. This enables frames to be transmitted and received, for example, between the ECU 3a or 3d connected to the communication bus 12a, the ECU 3b or 3e connected to the communication bus 12b, and the ECU 3c or 3f connected to the communication bus 12c.

### Configuration of Relay Device

In the first embodiment, it is assumed that the relay device 2 and the ECUs 3 can use the partial network function. The hardware configuration of the relay device 2 will be described below.

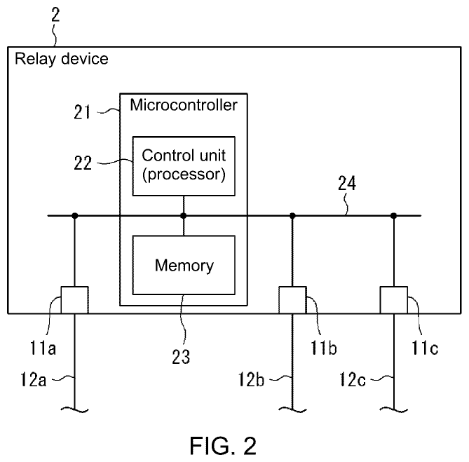

FIG. 2 is a block diagram illustrating an example of the configuration of the relay device according to the first embodiment. The relay device 2 includes a microcontroller unit 21 (hereinafter, referred to as the “microcontroller 21”), which includes a control unit 22 and a memory 23, and communication I/Fs 11a, 11b, and 11c. The control unit 22, the memory 23, and the communication I/Fs 11a, 11b, and 11c are electrically connected to each other via an internal bus 24.

The control unit 22 has the circuit configuration of a processor or the like. Specifically, the control unit 22 includes one or more central processing units (CPUs). The processor included in the control unit 22 may be a GPU (Graphics Processing Unit). In this case, the control unit 22 reads out a computer program stored in the memory 23 and executes various types of calculation and control.

The control unit 22 may include a processor in which a predetermined program is written in advance. For example, the control unit 22 may be an integrated circuit such as a Complex Programmable Logic Device (CPLD), a Field Programmable Gate Array (FPGA), or an Application Specific Integrated Circuit (ASIC). In this case, the control unit 22 executes various types of calculation and control based on programs written in advance.

The memory 23 includes a volatile memory and a non-volatile memory, and stores various types of data. One example of the volatile memory is a random access memory (RAM). Examples of the non-volatile memory include a flash memory, a hard disk drive (HDD), a solid state drive (SSD), and a read only memory (ROM). A portion of the non-volatile memory may be provided external to the microcontroller 21.

The memory 23 stores, for example, computer programs, later-described cluster information, and various parameters in the non-volatile memory. The memory 23 may store computer programs downloaded from an external device (not shown) via a network (not shown) and a communication device (not shown).

The communication I/Fs 11a, 11b, and 11c receive signals passing through the communication buses 12a, 12b, and 12c via respective ports (not shown) and convert the signals into signals that can be read by the microcontroller 21. The communication I/Fs 11a, 11b, and 11c are respectively connected to the communication buses 12a, 12b, and 12c.

### Configuration of ECU

The hardware configuration of the ECUs 3 will be described below.

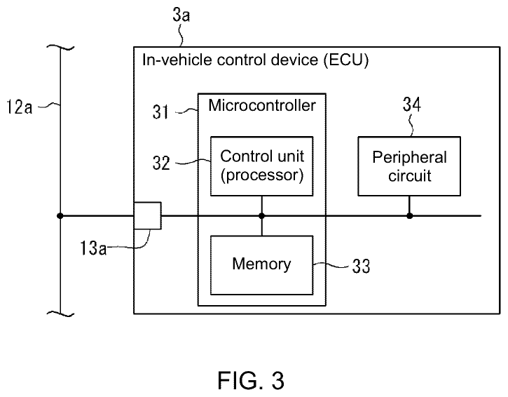

FIG. 3 is a block diagram illustrating an example of the configuration of one of the ECUs according to the first embodiment. The ECU 3a includes a microcontroller unit 31, the communication I/F 11a, and a peripheral circuit. The configurations of the ECUs 3b, 3c, 3d, 3e, and 3f are similar to that of the ECU 3a.

The microcontroller unit 31 (hereinafter referred to as the “microcontroller 31”) has the same configuration as the microcontroller 21 of the relay device 2 described above. In other words, the microcontroller 31 includes a control unit (processor) 32 and a memory 33 including a non-volatile memory and a volatile memory. The microcontroller 31 may include the peripheral circuit 34 and the communication I/F 11a.

The memory 33 stores a control program, which is a computer program, and data used to execute the control program. The control program can be stored in a recording medium such as a flash memory, or in a ROM or a CD-ROM, for example. By executing a control program, the processor 32 enables the ECU 3a to use the partial network function.

The peripheral circuit 34 includes a serial communication circuit that is compliant with a standard such as UART, I2C, or SPI. The serial communication circuit of the peripheral circuit 34 is connected to a device or a sensor that is to be controlled by the ECU 3a, and can receive signals output from sensors and transmit control signals to control targets.

The communication I/F 11a is a communication interface that is compliant with the above-mentioned communication protocol for the in-vehicle network. The communication I/F 11a is an I/F that supports the partial network function.

The ECUs 3 receive power from a power storage device and operate using the received power. Since the amount of power stored in the power storage device is limited, it is desirable that, after executing predetermined processing, the ECUs to transition to a sleep mode in which less power is consumed than when in the normal mode, in order to reduce power consumption as much as possible. If the ECUs operate for a long period of time, the power stored in the power storage device will gradually decrease, and the power storage device will enter an excessive discharge state in which the terminal voltage of the power storage device has dropped to the extent that the ECUs connected to the power storage device can no longer operate, and therefore it is desirable to appropriately cause the ECUs to transition to the sleep mode.

### Clusters

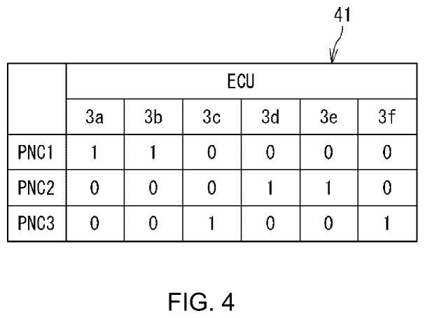

FIG. 4 is an example of a cluster table showing the ECUs that belong to each cluster. The clusters will be described below. Each of the ECUs 3 belongs to at least one cluster. The memory 23 of the relay device 2 stores a cluster table 41 in which the ECUs 3 are associated with the clusters to which the ECUs 3 belong. The cluster table 41 may be stored in the ECUs 3.

A cluster may be defined for, for example, each function provided to a user. The functions are executed by one or more ECUs.

Examples of functions executed by a plurality of ECUs include an automatic sliding door function, image sensor-based surroundings monitoring, and the charging of a battery for traveling (high-voltage battery) in an electric vehicle.

The automatic sliding door function is executed by, for example, a vehicle body ECU that controls movable parts of the vehicle body (e.g., a door lock, a power window, and a door mirror), and an input ECU that accepts switch input from the user. Therefore, the vehicle body ECU and the input ECU can belong to the same cluster.

Image sensor-based surroundings monitoring is executed by a sensor ECU connected to a human presence sensor that detects people in the surroundings of the vehicle, and an image ECU that acquires images from an image sensor. Therefore, the sensor ECU and the image ECU can belong to the same cluster.

Charging of the battery for traveling is executed by, for example, a charging ECU that controls charging of the battery for traveling and a detection ECU that detects whether or not a plug for transmitting charging power from a charging station is connected to a vehicle receptacle for receiving charging power. Therefore, the charging ECU and the detection ECU can belong to the same cluster.

Some functions are executed by a single ECU. Therefore, it is possible to set a cluster that includes only one ECU. Examples of functions executed by a single ECU include automatic steering adjustment and automatic seat adjustment.

Automatic steering adjustment is executed by a steering ECU for controlling power steering. Therefore, there is a cluster to which only the steering ECU belongs.

Automatic seat adjustment is executed by a seat ECU for controlling a power seat. Therefore, there is a cluster to which only the seat ECU belongs.

The cluster table 41 shown in FIG. 4 indicates which ECUs belong to each of three clusters PNC1 to PNC3. Note that the number of clusters in FIG. 4 is merely one example, and three or more clusters may be prepared. Fewer than three clusters may be provided. In the table, “1” indicates that the corresponding ECU belongs to the cluster in that row, and “0” indicates that the corresponding ECU does not belong to the cluster in that row.

For example, the ECUs 3a and 3d belong to the cluster PNC1. The ECUs 3d and 3e belong to the cluster PNC2. The ECUs 3c and 3f belong to the cluster PNC3. In the following description, the phrase “wake up the ECUs 3a and 3b that belong to the cluster PNC1” can also simply expressed as “wake up the cluster PNC1”. Similar expressions are used for the other clusters PNC2 and PNC3.

### Operation Modes

The operation modes and the wake-up operation of the ECUs 3 capable of executing the partial network function will be described below.

The operation modes of the ECUs 3 include a normal mode and a sleep mode. The normal mode is a state in which the ECUs 3 are operating and can control the control targets and communicate with other ECUs 3. The sleep mode is a state in which the ECUs 3 have stopped operating, with the exception of some functions of the communication I/Fs 13a, 13b, 13c, 13d, 13e, and 13f. Note that the communication I/Fs 13a, 13b, 13c, 13d, 13e, and 13f may be collectively referred to as “communication I/Fs 13” hereinafter.

In a CAN, when one or more clusters are to be woken up by the partial network function, a cluster frame designating the cluster that is to be woken up is transmitted via the communication buses 12a, 12b, and 12c. A wake-up request, which a cluster frame designating a cluster to be woken up, is transmitted by, for example, the ECU 3a. In the case of the ECU 3a, the cluster frame is created using the cluster table 41. However, the transmission source of the cluster frame is not limited to the ECU 3a, and the ECUs 3b, 3c, 3d, 3e, and 3f may transmit the cluster frame.

The communication I/Fs 13 of the ECUs 3 in the sleep mode receive the cluster frame and each determine whether or not the cluster to which the ECU 3 belongs is designated in the cluster frame. If the cluster to which the ECU belongs is not designated, the ECU remains in the sleep mode. If the cluster to which the device belongs is designated, the communication I/F 13 issues an interrupt to the control unit (processor) and instructs a switch from the sleep mode to the normal mode. As a result, the ECUs 3 that belong to the designated cluster wake up.

On the other hand, when processing related to an executed function ends in the ECUs 3, the ECUs 3 transition from the normal mode to the sleep mode. In other words, the ECU 3 that has received a cluster frame and transitioned from the sleep mode to the normal mode is configured to transition back to the sleep mode after a series of processing ends. Therefore, when the cluster frame is no longer received, the ECUs 3 transition to the sleep mode and remain in sleep mode. The ECUs 3 may be configured to transition to the sleep mode after a predetermined period of time has elapsed after a series of processing has ended.

The transition of the ECUs 3 to the sleep mode is not limited to be performed when the cluster frame is no longer received. For example, the ECUs 3 may be configured to transition to the sleep mode when a frame for transitioning to the sleep mode is received.

When the ECUs 3 transition from the sleep mode to the normal mode, the ECUs 3 operate at a high clock rate. In the sleep mode, operation of the ECUs 3 is stopped.

In the normal mode, the communication I/Fs 13 operate. In the sleep mode, some of the functions of the communication I/Fs 13 are stopped.

In the normal mode, the peripheral circuit 34 operates. In other words, in the normal mode, the ECUs 3 can receive signals output from sensors and control the control targets. In the sleep mode, operation of the peripheral circuit 34 is also stopped. In other words, in the sleep mode, the ECUs 3 cannot receive signals output from sensors or control the control targets.

In the normal mode described above, the power consumption of the ECUs 3 is high. In the sleep mode, the power consumption of the ECUs 3 is low.

### Functions of Relay Device

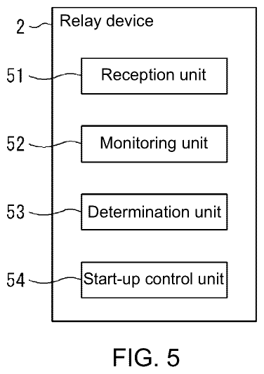

FIG. 5 is a functional block diagram illustrating an example of functions of the relay device according to the first embodiment.

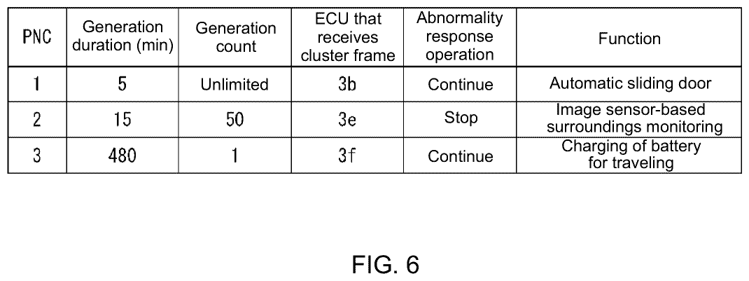

FIG. 6 is a diagram illustrating an example of determination references for determining whether a cluster is normal or abnormal.

The relay device 2 has the functions of a reception unit 51, a monitoring unit 52, a determination unit 53, and a start-up control unit 54. The reception unit 51, the monitoring unit 52, the determination unit 53, and the start-up control unit 54 are functions of the microcontroller 21. The functions of the reception unit 51, the monitoring unit 52, the determination unit 53, and the start-up control unit 54 are realized by the microcontroller 21 executing a control program.

### Reception Unit

The reception unit 51 receives a first cluster frame that was transmitted by a first in-vehicle control device, which belongs to a first cluster that executes a first function, with a second in-vehicle control device that belongs to the first cluster as the destination.

Specifically, the communication I/Fs 11a, 11b, and 11c of the relay device 2 receive signals passing through the communication buses 12a, 12b, and 12c via corresponding ports (not shown), and convert the received signals into signals that can be read by the microcontroller 21. The communication I/Fs 11a, 11b, and 11c are respectively connected to the communication buses 12a, 12b, and 12c.

For example, the ECUs 3a and ECU 3b belong to the cluster PNC1 that executes the automatic sliding door function. The ECU 3a is an input ECU that receives a switch input from a user. The ECUs 3b is a vehicle body ECU that controls the sliding door. When the user switches a door opening switch to the “open” position, the input ECU 3a transmits a cluster frame indicating that the sliding door is to be opened to the communication I/F 11a of the relay device 2 via the communication bus 12a.

The cluster frame transmitted to the communication I/F 11a of the relay device 2 is received by the communication I/F 11a and converted into a signal that can be read by the microcontroller 21. Due to the control unit 22 receiving the converted signal, the reception unit 51 receives the cluster frame that was transmitted by the ECU 3a with the ECU 3b as the destination.

### Monitoring Unit

The monitoring unit monitors the reception status of frames by the reception unit, and acquires the generation state of the first cluster frame transmitted by the first in-vehicle control device with the second in-vehicle control device as the destination. The first cluster frame generation state may include at least one of a generation duration indicating the duration for which the first cluster frame has been transmitted periodically, and a generation count indicating the number of times the first cluster frame has been generated. The first cluster frame is, for example, a cluster frame that indicates that a person has been detected and is transmitted by the ECU 3d, which belongs to the cluster PNC2 that executes an image sensor-based surroundings monitoring function, with the ECU 3e as the destination. For example, cluster frames are periodically transmitted on the CAN bus. The monitoring unit 52 monitors, for example, the cluster frame that the ECU 3d belonging to the cluster PNC2 periodically transmits to the ECU 3e, and obtains the generation duration for which the cluster frame has been periodically transmitted. Specifically, for example, in the case of a surroundings monitoring system that uses an image sensor, the duration is the period for which a person is being detected. Furthermore, the monitoring unit 52 monitors, for example, cluster frames that are transmitted by the ECU 3d that belongs to the cluster PNC2 with the ECU 3e as the destination, and obtains the generation count of the first cluster frame. Specifically, the generation count is, for example, the number of times a person has been detected in the surroundings monitoring system. The cluster frame generation count may be the number of times the cluster frame has been generated in a certain period of time.

In the case where there are a plurality of clusters, the monitoring unit 52 acquires the cluster frame generation state (i.e., the cluster frame generation duration and cluster frame generation count) for each cluster. In the case where there are three clusters as shown in FIG. 6, the monitoring unit 52 acquires the cluster frame generation state for the clusters PNC1 to PNC3.

### Determination Unit

The determination unit determines whether the first cluster is normal or abnormal based on the first cluster frame generation state acquired by the monitoring unit and determination references related to the frame generation state. The determination references for determining whether the first cluster is normal or abnormal include threshold values regarding the cluster frame generation state set for each cluster. The determination references include, for example, the cluster frame generation duration and generation count. The determination unit 53 may determine that a cluster is abnormal if either the cluster frame generation duration or the generation count acquired by the monitoring unit 52 exceeds the corresponding judgment determination reference, or may determine that a cluster is abnormal if both the generation duration and the generation count exceed the corresponding judgment determination references.

The determination references are information determined with consideration given to the functions of the corresponding clusters, and are presented in the form of a table, for example, as shown in FIG. 6. The determination references include information that is associated with identifiers identifying the corresponding clusters and indicate threshold values for the cluster frame generation duration and the generation count for the corresponding clusters. For example, the generation count is defined as 50 times. Furthermore, the determination references may include information indicating a response operation to be performed when a cluster has been determined to be abnormal. The response operations will be described later. The determination references are stored in the non-volatile memory of the memory 23 of the relay device 2, for example. The control unit 22 reads out the determination references stored in the memory 23. The determination unit 53 refers to the determination references that have been read out, and, for each cluster, determines whether or not the cluster is abnormal, based on the determination references and the data generation states acquired by the monitoring unit 52.

The generation duration determination reference may be determined for each cluster with consideration given to the functionality of the corresponding cluster. For example, in the case of the cluster for the automatic sliding door function, if the door is continuously left open for five minutes or more, it may be assumed that the user has forgotten to close the door, and this may be determined to be an abnormality. If the cluster has a function for monitoring the surroundings using an image sensor, it is unlikely that a person would be continuously detected around the vehicle for 15 minutes or more, and therefore this can be determined to be an abnormality. In the case of the cluster for the battery for traveling charging function, if the plug has been continuously inserted in the receptacle for 480 minutes or more, it may be assumed that the user forgot to remove the plug, and this may be determined to be an abnormality. Also, from the viewpoint of suppressing excessive discharge of the battery, the power consumption amount may be determined based on the power storage capacity of the power storage device that supplies power to the in-vehicle control devices and the amount of power consumed by the first cluster. For example, the determination is made with consideration given to the battery capacity and the power consumed by the sensor ECU 3d and the image ECU 3e. Assuming that the battery capacity is 50 AH (ampere hours), the maximum power consumption allowed for the image sensor-based surroundings monitoring function is 0.3 percent of the battery capacity, and assuming that the sensor ECU and image ECU consume a total of 0.6 A (amperes), the allowable operating time is 15 minutes.

The determination references for determining the generation count may be determined for each cluster, taking into account the function of the corresponding cluster. For example, in the case of the cluster for the automatic sliding door function, the generation count is not considered to be related to an abnormality in the cluster, and therefore no determination reference is set regarding the generation count. In the case of the cluster for the image sensor-based surroundings monitoring function, a situation in which a human presence sensor detects a person around the vehicle 50 times or more in a short period is considered abnormal. In the case of the cluster for the battery for traveling charging function, the plug remains inserted in the receptacle after charging begins, and therefore even in the case where the generation count is only “1”, if the generation duration exceeds the determination reference, the cluster may be determined to be abnormal.

For each cluster, giving consideration to the function of that cluster, it is possible to determine between deeming that the cluster is abnormal when either the generation duration determination reference or the generation count determination reference is exceeded, or deeming that the cluster is abnormal when both of the determination references are exceeded. In the case of the cluster for the automatic sliding door function, no determination reference is set regarding the generation count, and therefore if the generation duration exceeds the determination reference, the cluster is determined to be abnormal. In the case of the image sensor-based surroundings monitoring function, if either the generation duration or the generation count exceeds the corresponding determination reference, the cluster is considered to be abnormal, and therefore if either one of the determination references is exceeded, the cluster is determined to be abnormal. In the case of the cluster for the battery for traveling charging function, the plug remains inserted in the receptacle after charging begins, and therefore if the generation count is “1” or more, and furthermore the generation duration is 480 minutes or more, the cluster is considered to be abnormal. Therefore, if both the generation duration and the generation count exceed the determination references, the cluster is determined to be abnormal.

FIG. 6 shows the clusters PNC1 to PNC3 as examples of clusters. The cluster PNC1 is an example of the cluster for the automatic sliding door function. The cluster PNC2 is an example of the cluster for the image sensor-based surroundings monitoring function. The cluster PNC3 is an example of the cluster for the battery for traveling charging function.

In the example of the automatic sliding door function, when the user sets the door switch to the “open” position, the door opens. Specifically, the input ECU 3a receives switch input from the user, and the vehicle body ECU 3b controls a door drive system to open and close the door.

In the example of the image-sensor based surroundings monitoring function, for example, when a person is detected around the vehicle, an image of the surroundings is recorded by the image sensor. When the human presence sensor detects a person, the sensor ECU 3d connected to the human presence sensor transmits a cluster frame indicating that a person has been detected to the image ECU 3e. The image ECU 3e receives the cluster frame indicating that a person has been detected, and records an image of the surroundings of the vehicle.

An example of the battery for traveling charging function, this function is executed by, for example, the charging ECU 3f that controls charging of the battery for traveling and the detection ECU 3c that detects the vehicle receptacle that receives charging power. For example, when the detection ECU 3c detects that a plug at a charging station that transmits charging power has been connected to the vehicle receptacle that receives charging power, the detection ECU 3c transmits a cluster frame indicating that the plug has been connected to the receptacle to the charging ECU 3f. The charging ECU 3f receives the cluster frame indicating that the plug has been connected to the receptacle, and starts the charging of the battery for traveling.

### Start-up Control Unit

In the case where the determination unit determines that the first cluster is normal, the start-up control unit transmits the first cluster frame received from the first in-vehicle control device to the second in-vehicle control device, and in the case where the determination unit determines that the first cluster is abnormal, the start-up control unit does not transmit the first cluster frame received from the first in-vehicle control device to the second in-vehicle control device. Alternatively, in the case where the determination unit determines that the first cluster is abnormal, the start-up control unit may transmit, to the second in-vehicle control device, a stop frame for stopping operation of the second in-vehicle control device.

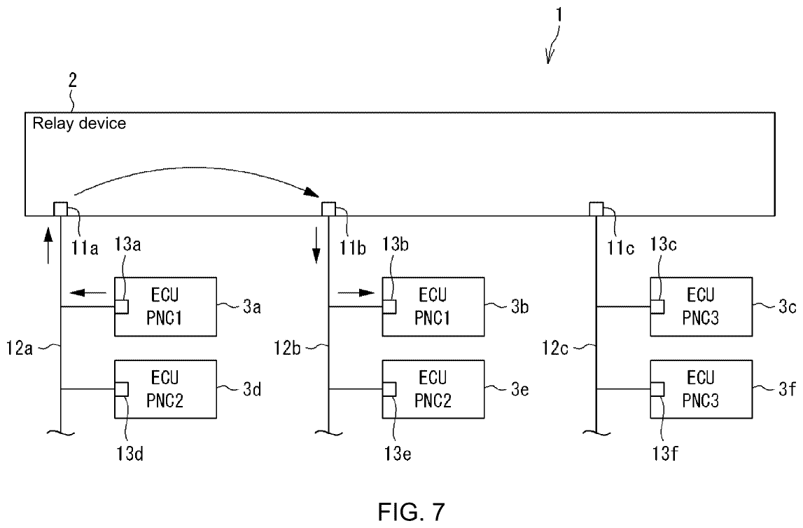

FIG. 7 is a schematic diagram illustrating a flow of cluster frames when the cluster frame generation state is normal. In the case where the determination unit 53 determines that the generation state of cluster frames transmitted by the ECU 3a with the ECU 3b as the destination is normal, the relay device 2 transmits the received cluster frame to the ECU 3b. The cluster frame transmitted from the ECU 3a via the communication I/F 13a is received by the relay device 2 via the communication I/F 11a. Since the determination unit 53 has determined that the relay device 2 is normal, the relay device 2 transmits the received cluster frame. The relay device 2 may acquire the transmission destination of the cluster frame by, for example, referring to the cluster table 41, or may acquire the transmission destination from the cluster frame.

For example, FIG. 4 illustrates an example of the cluster table. The ECUs 3a and 3b belong to the cluster PNC1, which corresponds to the automatic sliding door function. The ECUs 3d and 3e belong to the cluster PNC2, which corresponds to the image sensor-based surroundings monitoring function. The ECUs 3c and 3f belong to the cluster PNC3, which corresponds to the battery for traveling charging function.

The relay device 2 refers to the cluster table 41 to acquire the transmission destination of the cluster frame. Since the ECUs 3a and ECU 3b belong to the cluster PNC1, which corresponds to the automatic sliding door function, the transmission destination ECU is the ECU 3b. The relay device 2 relays the cluster frame transmitted by the ECU 3a, and transmits the cluster frame to the ECU 3b via the communication I/F 11b and the communication bus 12b. The ECU 3b that receives the cluster frame executes the automatic sliding door function, which is the function of the cluster PNC1.

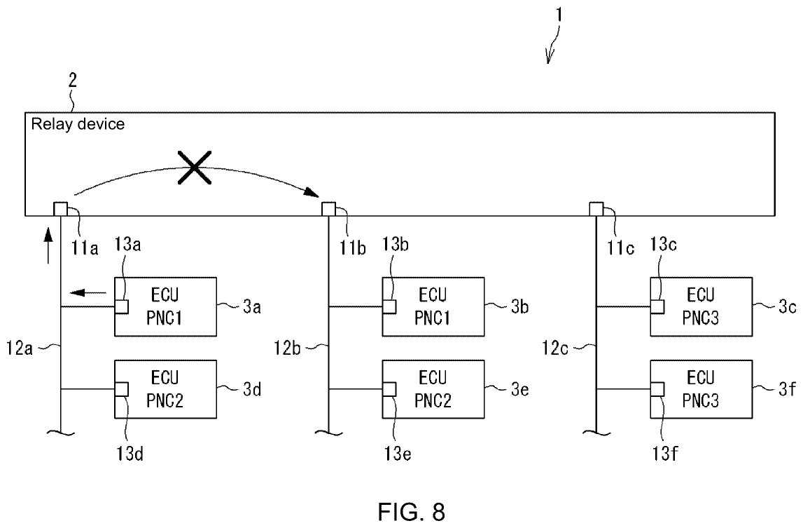

FIG. 8 is a schematic diagram illustrating a flow of cluster frames when the data generation state is abnormal, and shows an example in which a received cluster frame is not transmitted to the transmission destination ECU, and operation of the transmission destination ECU is stopped. In the case where the determination unit 53 determines that the generation state of cluster frames transmitted by the ECU 3a with the ECU 3b as the destination is abnormal, the relay device 2 does not transmit the cluster frame to the ECU 3b. As described above, the ECU 3b is configured to transition to the sleep mode after a series of processing ends, and therefore when the cluster frame is no longer received, the ECU 3b transitions to the sleep mode and remains in the sleep mode.

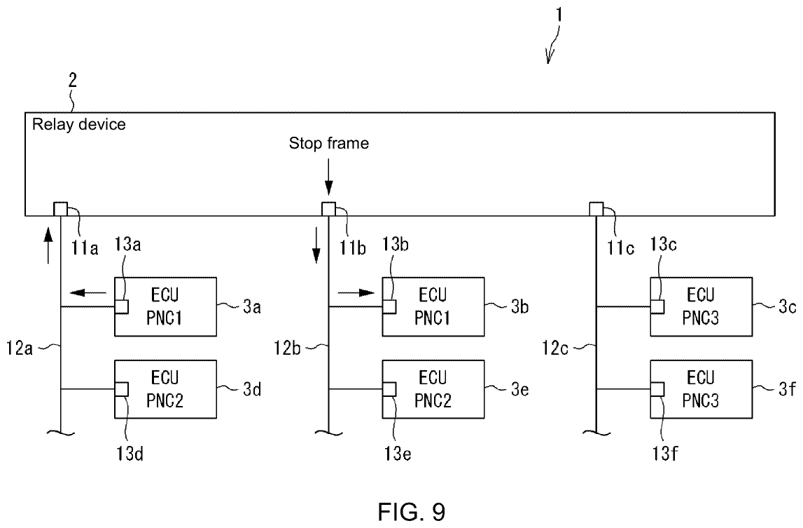

FIG. 9 is a schematic diagram illustrating a flow of data in the case where the data generation state is abnormal. Unlike the example in FIG. 8, this is an example in which a stop frame for stopping operation of an ECU is transmitted to the transmission destination ECU, thereby stopping operation of the transmission destination ECU. When the ECU 3b receives the stop frame instructing a transition to the sleep mode, the ECU 3b transitions to the sleep mode.

### ECU Operation

The operation of the relay device according to the first embodiment will be described below.

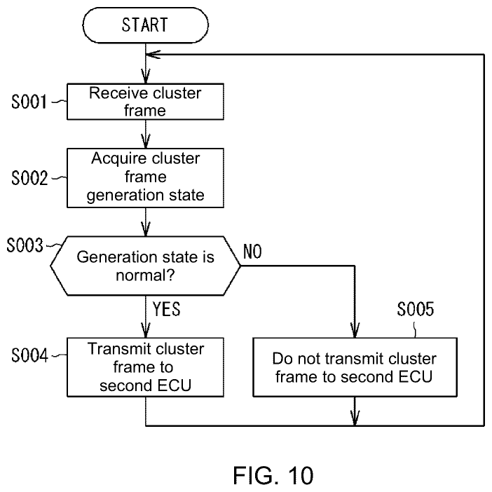

FIG. 10 is a flowchart illustrating an example of operation of the relay device according to the first embodiment.

### Step S001

The reception unit 51 receives the first cluster frame that was transmitted by the first in-vehicle control device, which belongs to the first cluster that executes the first function, with the second in-vehicle control device that belongs to the first cluster as the destination (step S001).

Specifically, the communication I/Fs 11a, 11b, and 11c of the relay device 2 respectively receive signals passing through the communication buses 12a, 12b, and 12c via corresponding ports (not shown), and convert the received signals into signals that the microcontroller 21 can read. The communication I/Fs 11a, 11b, and 11c are respectively connected to the communication buses 12a, 12b, and 12c.

For example, in the case of the cluster PNC1 that executes the automatic sliding door function, when the user switches the switch for opening the door to the “open” position, the switch ECU 3a transmits a cluster frame indicating that the sliding door is to be opened to the communication I/F 11a of the relay device 2 via the communication bus 12a (see FIGS. 4, 6 and 7). The cluster frame transmitted to the communication I/F 11a of the relay device 2 is received by the communication I/F 11a and converted into a signal that the microcontroller 21 can read. Due to the control unit 22 receiving the converted signal, the reception unit 51 receives the data transmitted by the ECU 3a with the ECU 3b as the destination. When the reception unit 51 receives the data, the processing proceeds to step S002.

### Step S002

The monitoring unit 52 monitors the frame reception status of the reception unit, and acquires the generation state of the first cluster frames transmitted by the first in-vehicle control device with the second in-vehicle control device as the destination (step S002). The first cluster frame generation state may include at least one of the generation duration indicating the duration for which the first cluster frame has been transmitted periodically, and the generation count indicating the number of times the first cluster frame has been generated.

The monitoring unit 52 monitors, for example, the cluster frame that the ECU 3a, which belongs to the cluster PNC1, periodically transmits to the ECU 3b, and acquires the cluster frame generation duration. The monitoring unit 52 also monitors cluster frame transmitted, for example, by the ECU 3a, which belongs to the cluster PNC1, with the ECU 3b as the destination, and acquires the first cluster frame generation count. The data generation count may be the number of times that the data is generated in a certain period of time. In the case where there are three clusters as shown in FIG. 6, the monitoring unit 52 acquires the cluster frame generation state of the clusters PNC1 to PNC3. When the monitoring unit 52 has acquired the cluster frame generation state, the processing proceeds to step S003.

### Step S003

The determination unit 53 determines whether the first cluster is normal or abnormal based on the first cluster frame generation state acquired by the monitoring unit 52 and the determination references related to the frame generation state (step S003). The determination unit 53 may determine that a cluster is abnormal if either the cluster frame generation duration or the generation count acquired by the monitoring unit 52 exceeds the corresponding judgment determination reference, or may determine that a cluster is abnormal if both the generation duration and the generation count exceed the corresponding judgment determination references.

The determination references include, for example, threshold values regarding the cluster frame generation duration and generation count, and are, for example, information in a table format as shown in FIG. 6. The determination references are stored in the non-volatile memory of the memory 23 of the relay device 2, for example. The control unit 22 reads out the determination references stored in the memory 23. The determination unit 53 refers to the determination references that have been read out, and, for each cluster, determines whether or not the cluster is abnormal based on the determination references and the data generation state acquired by the monitoring unit.

For example, regarding the determination references, assume here that the threshold value for the generation duration is 15 minutes, and the threshold value for the generation count is 50. If the cluster frame generation duration acquired by the monitoring unit 52 is 10 minutes and the generation count is 12, the determination unit 53 determines that the cluster is not abnormal. If the cluster frame generation duration is 16 minutes and the generation count is 12, the determination unit 53 determines that the cluster is abnormal. If the data generation duration is 10 minutes and the generation count is 60, the determination unit 53 also determines that the cluster is abnormal. If the determination unit 53 determines that the cluster is normal, the processing proceeds to step S004, and if the determination unit 53 determines that the cluster is abnormal, the processing proceeds to step S005.

### Steps S004 and S005

In the case where the determination unit 53 determines that the first cluster is normal, the start-up control unit 54 transmits the first cluster frame received from the first in-vehicle control device to the second in-vehicle control device (step S004), and in the case where the determination unit 53 determines that the first cluster is abnormal, the start-up control unit 54 does not transmit the first cluster frame received from the first in-vehicle control device to the second in-vehicle control device (step S005).

For example, in the case where the determination unit 53 determines that the generation state of cluster frames transmitted by the ECU 3a with the ECU 3b as the destination is normal, the relay device 2 transmits the cluster frame to the ECU 3b. The relay device 2 acquires the transmission destination of the cluster frame by referring to a cluster table such as that shown in FIG. 4. Alternatively, the relay device 2 may acquire information indicating the transmission destination contained in the cluster frame. The ECU 3b that receives the cluster frame executes the automatic sliding door function, which is the function of the cluster PNC1. After transmitting the cluster frame, the relay device 2 returns to step S001 again and receives cluster frames.

On the other hand, in the case where the determination unit 53 determines that the generation state of the cluster frame transmitted by the ECU 3a to the relay device 2 is abnormal, the relay device 2 does not transmit the received cluster frame to the ECU 3b. The ECU 3b is configured to transition to the sleep mode after a series of processing ends, and therefore when the cluster frame is no longer received, the ECU 3b transitions to the sleep mode and remains in the sleep mode. If the relay device 2 has not transmitted a cluster frame, the processing returns to step S001 again in order to receive cluster frames of clusters other than the cluster determined to be abnormal.

Alternatively, in the case where the determination unit 53 determines that the first cluster is abnormal, the start-up control unit 54 may transmit a stop frame for stopping operation of the second in-vehicle control device to the second in-vehicle control device (step S005). Upon receiving the stop frame for stopping ECU operation, the ECU 3b transitions to the sleep mode. Even in the case where the relay device 2 has transmitted a stop frame, the processing returns to step S001 again in order to receive cluster frames of clusters other than the cluster determined to be abnormal.

### Summary

As a result, cluster frames are not transmitted to ECUs that belong to a cluster determined to be abnormal. An ECU that no longer receives a cluster frame transitions the sleep mode. Alternatively, a stop frame is transmitted to the ECUs that belong to a cluster that has been determined to be abnormal, and the ECUs that receive the stop frame transition to the sleep mode. As a result, it is possible to stop operation of the second in-vehicle control device that belongs to the cluster determined to be abnormal, thereby suppressing the power consumption of the in-vehicle system.

### Second Embodiment

### Details of Second Embodiment of Present Disclosure

Hereinafter, a second embodiment of the present disclosure will be described in detail with reference to the drawings.

In the second embodiment, the relay device 2 further includes a notification unit as a functional block, and other configurations are the same as those in the first embodiment. Also, some of the functions of the start-up control unit 54 are different. The same components as those in the first embodiment are denoted by the same reference numerals, and descriptions will not be given for such components, functions, and operations that are the same.

### Configuration of Relay Device

The configuration of the relay device of the second embodiment is the same as that of the first embodiment.

### Problems to Be Solved by Present Embodiment

In the first embodiment, when it is determined that a cluster is abnormal, the start-up control unit 54 does not transmit a cluster frame to the ECUs that belong to the cluster determined to be abnormal, and therefore those ECUs stop operating. In such a case, it is desirable to notify the user that the cluster is abnormal. Also, upon finding out that a cluster is abnormal, the user may desire to execute the function of that cluster. Alternatively, if the function of a certain cluster is important, even when that cluster is determined to be abnormal, it may be desirable to cause the function of that cluster to be executed. An object of the second embodiment is to meet such demands.

### Functions of Relay Device

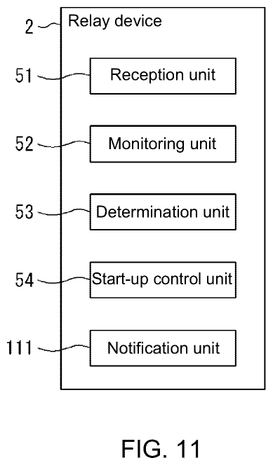

FIG. 11 is a functional block diagram illustrating an example of functions of the relay device according to the second embodiment. In the second embodiment, the relay device 2 further includes a notification unit 111 as a functional block.

### Notification Unit

In the case where the determination unit determines that an abnormality has occurred, the notification unit notifies the user that the first cluster is abnormal.

In the example of the automatic sliding door function, the determination unit 53 determines that an abnormality has occurred if, for example, the door has been continuously open for five minutes or more, which exceeds the determination references of five minutes. If the determination unit 53 determines that an abnormality has occurred, the user is notified that the corresponding cluster is abnormal. Specifically, for example, if the vehicle has an audio notification device (not shown), and furthermore the notification device is controlled by a notification ECU (not shown), the relay device 2 transmits, to the notification ECU, a cluster frame for notifying the notification ECU that the cluster PNC1 corresponding to the automatic sliding door function is abnormal. The notification device controlled by the notification ECU gives an audio announcement in the vehicle with a message saying “The door has been left open. Please check it.” Alternatively, the notification may be sent to the user's smartphone.

As a result, the user can become aware that a cluster is abnormal, such as the case where a door has been left open. The alerted user can then take an appropriate action such as closing the door.

### Start-up Control Unit

Both in the case where the determination unit 53 determines that the second cluster is normal and in the case where the determination unit 53 determines that the second cluster is abnormal, the start-up control unit 54 transmits a second cluster frame transmitted from a third in-vehicle control device to a fourth in-vehicle control device. Here, the reception unit 51 receives the second cluster frame transmitted by the third in-vehicle control device, which belongs to the second cluster that executes a second function, with the fourth in-vehicle control device that belongs to the second cluster as the destination, the monitoring unit 52 acquires the generation state of second cluster frames transmitted by the third in-vehicle control device with the fourth in-vehicle control device as the destination, and the determination unit 53 determines whether or not the second cluster is normal or abnormal based on the second cluster frame generation state acquired by the monitoring unit 52 and the determination references.

Note that the first function may be a function that is executed when the remaining capacity of the power storage device that supplies power to in-vehicle control devices is a specified value or higher, and the second function may be a function that is executed even when the remaining capacity is below the specified value.

In the first embodiment, if it has been determined that a cluster is normal, the start-up control unit 54 transmits a cluster frame to the transmission destination ECU, and if it has been determined that a cluster is abnormal, the start-up control unit 54 does not transmit a cluster frame to the transmission destination ECU. However, in the second embodiment, if it has been determined that a cluster is normal, a cluster frame is transmitted to the transmission destination ECU, and even if it has been determined that a cluster is abnormal, a cluster frame is transmitted to the transmission destination ECU.

In other words, even if a cluster has been determined to be abnormal, a cluster frame is transmitted to the transmission destination ECU, and the ECU that receives the cluster frame executes the function of the cluster. Examples of cases in which the ECU executes the function of the cluster even when it has been determined that an abnormality has occurred include the case where the function is an important function that needs to be executed even when the remaining capacity of the power storage device is below a specified value, and the case where an abnormality has occurred but the ECU power consumption is small and the impact on the power storage device is minor.

In the case where the determination unit 53 determines that an abnormality has occurred, whether or not the function of the corresponding cluster is to be executed is determined for each cluster. FIG. 6 shows an example of a column indicating response operations to be performed when an abnormality has occurred. The start-up control unit 54 refers to the cluster table in FIG. 6, reads out information on the abnormality response operation that is associated with the cluster, and if the information indicates “stop”, the start-up control unit 54 stops the function of the cluster. In this example, the cluster is the cluster that executes the first function. In this case, the start-up control unit 54 does not transmit the cluster frame, or transmits a stop frame. On the other hand, if the information on the response operation in the event of an abnormality indicates “continue”, the function of the cluster is executed. In this example, the cluster is the cluster that executes the second function. In this case, the start-up control unit 54 transmits the cluster frame to the ECUs that belong to the cluster. Upon receiving the transmitted cluster frame, the corresponding ECUs execute the function of the cluster.

As a result, even if a cluster is determined to be abnormal, it is possible to execute a cluster function that needs to be executed even when the remaining capacity of the power storage device is below a specified value, and to also execute a cluster function that has only a minor effect on the power storage device even if executed.

Furthermore, in the case where the notification unit 111 has given a notification that the first cluster is abnormal, if the relay device 2 receives a command from the user to continue executing the first function, the start-up control unit 54 transmits the first cluster frame transmitted from the first in-vehicle control device to the second in-vehicle control device.

In the case where the determination unit 53 determines that an abnormality has occurred and the information on the abnormality response operation in the cluster table indicates “stop”, the start-up control unit 54 does not transmit the cluster frame, or transmits a stop frame. In this case, the notification unit 111 has already notified the user that the cluster is abnormal. For example, an audio message saying “The surroundings monitoring system has been recording for 15 minutes or more.” may be announced in the vehicle. Upon hearing this message, if the user wishes to continue using the image sensor-based surroundings monitoring function for some reason, the user can give an instruction to execute that function by, for example, operating their smartphone. Upon receiving the command indicating that instruction, the start-up control unit 54 of the relay device 2 transmits a cluster frame to the ECUs that belong to the cluster corresponding to the function.

As a result, even if, for example, the surroundings monitoring system has been recording for 15 minutes or more and the determination unit 53 determines that the cluster is abnormal, the function can be executed based on the user's instruction if the user intends for the function to be executed.

### Relay Device Operation

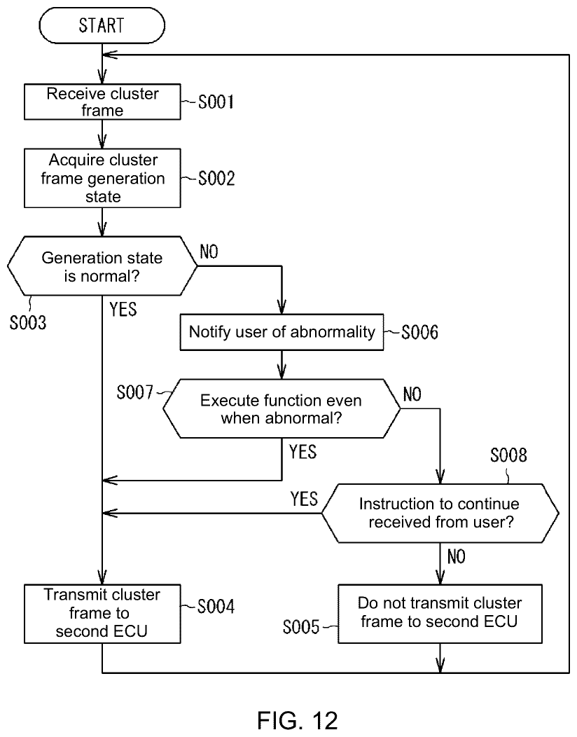

FIG. 12 is a flowchart illustrating an example of operation of the relay device according to the second embodiment. The operation of the relay device according to the second embodiment will be described below. The operations of steps S001 to S005 are the same as those in the first embodiment, and therefore the description thereof will be omitted. The second embodiment differs from the first embodiment with respect to operations performed after the determination unit 53 determines in step S003 that a cluster is abnormal. The operations performed after the determination unit 53 determines that a cluster is abnormal will be described below. In the second embodiment, in the case where the determination unit 53 determines that a cluster is abnormal, the processing proceeds to step S006 instead of step S005.

### Step S006

In the case where the determination unit 53 determines that an abnormality has occurred, the notification unit 111 notifies the user that the first cluster is abnormal. (Step S006).

Specifically, for example, if the vehicle has an audio notification device (not shown), and furthermore the notification device is controlled by a notification ECU (not shown), the relay device 2 transmits, to the notification ECU, a command for notifying the notification ECU that the cluster PNC1 corresponding to the automatic sliding door function is abnormal. After the user has been notified, the relay device 2 proceeds to step S007.

### Step S007

Both in the case where the determination unit 53 determines that the second cluster is normal and in the case where the determination unit 53 determines that the second cluster is abnormal, the start-up control unit 54 transmits a second cluster frame transmitted from a third in-vehicle control device to a fourth in-vehicle control device.

In the case where the determination unit 53 determines that an abnormality has occurred, it is determined whether or not the function of that cluster is to be executed, and this determination is made for each cluster. FIG. 6 shows an example of a column indicating response operations to be performed when an abnormality has occurred. The start-up control unit 54 refers to the cluster table in FIG. 6, reads out information on the abnormality response operation that is associated with the cluster, and if the information indicates “stop”, the processing proceeds to step S008. On the other hand, if the information on the abnormality response operation indicates “continue”, the processing proceeds to step S004. When the processing proceeds to step S004, the start-up control unit 54 transmits a cluster frame to the ECUs that belongs to the cluster.

### Step S008

In the case where the notification unit 111 has given a notification that the first cluster is abnormal, if the relay device 2 receives a command from the user to continue executing the first function, the start-up control unit 54 transmits the first cluster frame transmitted from the first in-vehicle control device to the second in-vehicle control device (step S008).

In the case where the determination unit 53 determines that an abnormality has occurred and the information on the abnormality response operation in the cluster table indicates “stop”, the start-up control unit 54 does not transmit the cluster frame, or transmits a stop frame. In this case, the notification unit 111 has already notified the user that the cluster is abnormal. If the user intends to continue the function of the cluster for some reason, the user, for example, operates a smartphone to give an instruction for executing the function to the relay device 2. Upon receiving a command indicating this instruction, the relay device 2 proceeds to step S004, and the start-up control unit 54 transmits a cluster frame to the ECUs that belong to the cluster corresponding to the function. Upon receiving the cluster frame, the corresponding ECUs execute the function of the cluster.

On the other hand, if the user does not intend for the function of the cluster to be executed, the user does not give an instruction to execute the function. Therefore, due to not receiving a command indicating that instruction, the relay device 2 proceeds to step S005, and the start-up control unit 54 does not transmit a cluster frame to the ECUs that belong to the cluster corresponding to the function, or transmits a stop frame. The ECUs that do not receive the cluster frame or receive a stop frame transition to the sleep mode.

### Summary

Due to the function of the notification unit 111, the user can find out that there is an abnormality in the cluster, such as that a door has been left open. The alerted user can then take an appropriate action such as closing the door.

Due to the function of the start-up control unit 54, it is possible to execute a function that needs to be executed even when the remaining capacity of the power storage device is less than a specified value. Furthermore, even in the case where the determination unit 53 determines that a cluster is abnormal, the cluster can execute the corresponding function based on a user instruction if the user intends for the function to be executed.

### Modified Example 1

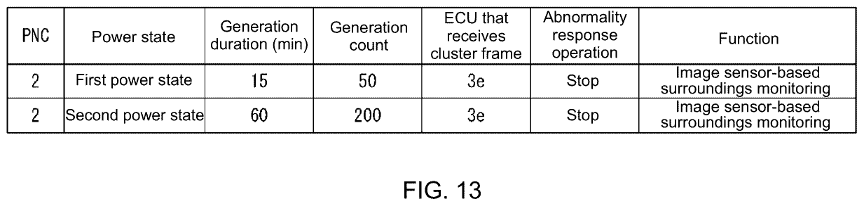

FIG. 13 is a diagram illustrating an example of determination references in a first modified example of the relay device 2. The functions and configurations are the same as those of the first embodiment, with the exception that the function of the determination unit 53 is partially different. In the case where the power storage device that supplies power to the in-vehicle control device is not being charged, the determination unit determines whether the first cluster is normal or abnormal based on a first determination reference, and in the case where the power storage device is being charged, the determination unit determines whether the first cluster is normal or abnormal based on a second determination reference more relaxed than the first determination reference.

The ECUs acquire power needed for operation from the power storage device installed in the vehicle. If the vehicle is a gasoline engine vehicle, the power storage device is charged with power generated by a generator driven by the engine installed in the vehicle. Therefore, while the engine is rotating and the vehicle is capable of traveling, that is, in the so-called IG state, the power storage device is charged, and there is little risk that the power storage device will become discharged excessively and enter the excessive discharge state. For this reason, the determination reference that is referenced while the power storage device is not being charged may be relaxed.

In a first power supply state in which the power storage device is not being charged, the determination unit 53 in this modified example refers to the determination references in the upper row shown in FIG. 13 in the case of the image sensor-based surroundings monitoring function, for example. In this case, the determination references include the generation duration threshold value of 15 minutes and the generation count threshold value of 50, and the determination unit 53 determines whether or not the cluster is abnormal or normal. On the other hand, in the case of a second power supply state in which the power storage device is being charged, the determination references in the lower row of FIG. 13 are referred to. In this case, the determination references include the generation duration threshold value of 60 minutes and the generation count threshold value of 200, and the determination unit 53 determines whether or not the cluster is abnormal or normal.

Accordingly, there may be a cluster that would be determined to be abnormal if the power storage device were not being charged, but would not necessarily be said to be abnormal if the power storage device were being charged, and it is possible to appropriately determine whether or not such a cluster is normal or abnormal.

### Modified Example 2

There are cases where a plurality of clusters are executed concurrently. In such a case, for example, two clusters may be executed by the same ECU. The ECU that needs to execute the functions of two clusters receives cluster frames corresponding to the respective cluster functions in order for the functions to be executed. Therefore, the cluster frame generation duration and generation count for that ECU may be higher than in the case of executing one cluster. In such a situation, if a cluster is determined to be abnormal or normal based on each of the determination references for the clusters corresponding to the functions, there is a risk that the cluster will be erroneously determined to be abnormal even though it is actually normal.

Therefore, in the case where the first function is being executed alone, the determination unit 53 determines whether the first cluster is normal or abnormal based on a first determination reference, and in the case where the first function and the second function are being executed concurrently, the determination unit 53 determines whether the first cluster is normal or abnormal based on a second determination reference that is more relaxed than the first determination reference (note that the first in-vehicle control device further belongs to a second cluster that executes a second function different from the first function).

For example, in the example of the cluster table shown in FIG. 4, consider the case where the ECUs 3d and 3e belong to the cluster PNC2, the ECUs 3c and 3f belong to the cluster PNC3, and the ECU 3d also belongs to the cluster PNC3. In the case where the cluster PNC2 and the cluster PNC3 are being executed concurrently, the ECU 3d may generate many cluster frames to execute the functions of the cluster PNC2 and the cluster PNC3. In such a situation, if the determination unit 53 refers to the determination references shown in FIG. 6 when determining whether a cluster is normal or abnormal, the upper limit of the generation count determination reference for the cluster PNC3 is 1, and therefore there is a risk that the determination reference upper limit will be exceeded quickly and the cluster PNC3 will be determined to be abnormal.

In order to avoid such an erroneous determination, the determination references are changed based on the determination references of the cluster PNC2 and the determination references of the cluster PNC3. For example, the determination reference generation count of the cluster PNC2 and the determination reference generation count of the cluster PNC3 are added together, but there is no limitation to this.

As a result, in the case where the clusters PNC2 and PNC3 are being executed concurrently, a load is placed on the ECU 3d that belongs to both clusters, and even if it may be determined that a cluster is abnormal based on the determination references of the cluster PNC2 or the determination references of the cluster PNC3 even though the cluster is not actually abnormal, by changing the determination references, it is possible to avoid the case where the cluster is determined to be abnormal and the functions of the cluster PNC2 and the cluster PNC3 are stopped.

### Supplementary Note 1

The present disclosure includes the vehicle control system described below.

A vehicle control system includes a relay device for relaying communication between in-vehicle control devices that communicate with each other via a communication bus, and the in-vehicle control devices connected to the communication bus, the relay device including: a reception unit configured to receive a first cluster frame transmitted by a first in-vehicle control device, which belongs to a first cluster that executes a first function, with a second in-vehicle control device belonging to the first cluster as a destination; a monitoring unit configured to monitor a frame reception status of the reception unit and acquire a generation state of the first cluster frame transmitted by the first in-vehicle control device with the second in-vehicle control device as a destination; a determination unit configured to determine whether the first cluster is normal or abnormal based on the generation state of the first cluster frame acquired by the monitoring unit and a determination reference regarding a frame generation state; and a start-up control unit configured to, in a case where the determination unit determines that the first cluster is normal, transmit the first cluster frame received from the first in-vehicle control device to the second in-vehicle control device, and in a case where the determination unit determines that the first cluster is abnormal, not transmit the first cluster frame received from the first in-vehicle control device to the second in-vehicle control device. According to this configuration, in the vehicle control system, it is possible to stop operation of the second in-vehicle control device that belongs to the cluster determined to be abnormal, thereby suppressing the power consumption of the in-vehicle system.

### Supplementary Note 2

The present disclosure includes the vehicle described below.

A vehicle includes a relay device for relaying communication between in-vehicle control devices that communicate with each other via a communication bus, and the in-vehicle control devices connected to the communication bus, the relay device including: a reception unit configured to receive a first cluster frame transmitted by a first in-vehicle control device, which belongs to a first cluster that executes a first function, with a second in-vehicle control device belonging to the first cluster as a destination; a monitoring unit configured to monitor a frame reception status of the reception unit and acquire a generation state of the first cluster frame transmitted by the first in-vehicle control device with the second in-vehicle control device as a destination; a determination unit configured to determine whether the first cluster is normal or abnormal based on the generation state of the first cluster frame acquired by the monitoring unit and a determination reference regarding a frame generation state; and a start-up control unit configured to, in a case where the determination unit determines that the first cluster is normal, transmit the first cluster frame received from the first in-vehicle control device to the second in-vehicle control device, and in a case where the determination unit determines that the first cluster is abnormal, not transmit the first cluster frame received from the first in-vehicle control device to the second in-vehicle control device. According to this configuration, in the vehicle, it is possible to stop operation of the second in-vehicle control device that belongs to the cluster determined to be abnormal, thereby suppressing the power consumption of the in-vehicle system.

### Supplementary Note 3

The embodiments disclosed herein are illustrative in all respects and are not restrictive. The scope of the present disclosure is defined by the claims rather than the above-described embodiments, and includes meanings equivalent to the claims and all modifications within the scope thereof.

1. A relay device for relaying communication between in-vehicle control devices that communicate with each other via a communication bus, the relay device comprising:
a reception unit configured to receive a first cluster frame transmitted by a first in-vehicle control device, which belongs to a first cluster that executes a first function, with a second in-vehicle control device belonging to the first cluster as a destination;
a monitoring unit configured to monitor a frame reception status of the reception unit and acquire a generation state of the first cluster frame transmitted by the first in-vehicle control device with the second in-vehicle control device as a destination;
a determination unit configured to determine whether the first cluster is normal or abnormal based on the generation state of the first cluster frame acquired by the monitoring unit and a determination reference regarding a frame generation state; and
a start-up control unit configured to, in a case where the determination unit determines that the first cluster is normal, transmit the first cluster frame received from the first in-vehicle control device to the second in-vehicle control device, and in a case where the determination unit determines that the first cluster is abnormal, not transmit the first cluster frame received from the first in-vehicle control device to the second in-vehicle control device.

2. The relay device according to claim 1, wherein in a case where the determination unit determines that the first cluster is abnormal, the start-up control unit transmits, to the second in-vehicle control device, a stop frame for stopping operation of the second in-vehicle control device.

3. The relay device according to claim 1, wherein the generation state of the first cluster frame includes at least one of a generation duration indicating a duration for which the first cluster frame has been transmitted periodically, and a generation count of the first cluster frame.

4. The relay device according to claim 1, wherein in a case where a power storage device for supplying power to the in-vehicle control devices is not being charged, the determination unit determines whether the first cluster is normal or abnormal based on a first determination reference, and in a case where the power storage device is being charged, the determination unit determines whether the first cluster is normal or abnormal based on a second determination reference more relaxed than the first determination reference.

5. The relay device according to claim 1,
wherein the reception unit receives a second cluster frame transmitted by a third in-vehicle control device, which belongs to a second cluster that executes a second function, with a fourth in-vehicle control device belonging to the second cluster as a destination,
the monitoring unit acquires a generation state of the second cluster frame transmitted by the third in-vehicle control device with the fourth in-vehicle control device as a destination,
the determination unit determines whether the second cluster is normal or abnormal based on the generation state of the second cluster frame acquired by the monitoring unit and the determination reference, and
in both a case where the determination unit determines that the second cluster is normal and a case where the determination unit determines that the second cluster is abnormal, the start-up control unit transmits the second cluster frame received from the third in-vehicle control device to the fourth in-vehicle control device.

6. The relay device according to claim 5, wherein the first function is a function executed in a case where a remaining capacity of a power storage device for supplying power to the in-vehicle control devices is a specified value or higher, and
the second function is a function executed even in a case where the remaining capacity is below the specified value.

7. The relay device according to claim 1, further including;
a notification unit configured to, in a case where the determination unit determines that the first cluster is abnormal, notify a user that the first cluster is abnormal.

8. The relay device according to claim 7, wherein in a case where the notification unit notified the user that the first cluster is abnormal, if the relay device receives a command to continue execution of the first function from the user, the start-up control unit transmits the first cluster frame received from the first in-vehicle control device to the second in-vehicle control device.

9. The relay device according to claim 1,
wherein the first in-vehicle control device further belongs to a second cluster that executes a second function different from the first function, and
in a case where the first function is being executed alone, the determination unit determines whether the first cluster is normal or abnormal based on a first determination reference, and in a case where the first function and the second function are being executed concurrently, the determination unit determines whether the first cluster is normal or abnormal based on a second determination reference more relaxed than the first determination reference.

10. The relay device according to claim 1, wherein the determination reference is determined based on a power storage capacity of a power storage device for supplying power to the in-vehicle control devices and an amount of power consumed by the first cluster.

11. A control method for controlling a relay device for relaying communication between in-vehicle control devices that communicate with each other via a communication bus, the control method comprising the steps of:
receiving a first cluster frame transmitted by a first in-vehicle control device, which belongs to a first cluster that executes a first function, with a second in-vehicle control device belonging to the first cluster as a destination;
monitoring a frame reception status of received frames and acquiring a generation state of the first cluster frame transmitted by the first in-vehicle control device with the second in-vehicle control device as a destination;
determining whether the first cluster is normal or abnormal based on the acquired generation state of the first cluster frame and a determination reference regarding a frame generation state; and
in a case where the first cluster is determined to be normal, transmitting the first cluster frame received from the first in-vehicle control device to the second in-vehicle control device, and in a case where the first cluster is determined to be abnormal, not transmitting the first cluster frame received from the first in-vehicle control device to the second in-vehicle control device.

12. A computer program for use in a relay device for relaying communication between in-vehicle control devices that communicate with each other via a communication bus, the computer program causing execution of the steps of:
receiving a first cluster frame transmitted by a first in-vehicle control device, which belongs to a first cluster that executes a first function, with a second in-vehicle control device belonging to the first cluster as a destination;
monitoring a frame reception status of received frames and acquiring a generation state of the first cluster frame transmitted by the first in-vehicle control device with the second in-vehicle control device as a destination;
determining whether the first cluster is normal or abnormal based on the acquired generation state of the first cluster frame and a determination reference regarding a frame generation state; and
in a case where the first cluster is determined to be normal, transmitting the first cluster frame received from the first in-vehicle control device to the second in-vehicle control device, and in a case where the first cluster is determined to be abnormal, not transmitting the first cluster frame received from the first in-vehicle control device to the second in-vehicle control device.
